(19) United States
(12) Patent Application Publication
(10) Pub. No.: US 2018/0066760 A1
(43) Pub. Date: Mar. 8, 2018

(54) Pressure Reducing Valve

(71) Applicant: Rausch & Pausch GmbH, Selb (DE)

(72) Inventors: Martin KÖPPEL, Döhlau (DE); Rocco Kemnitz, Bobenneukirchen (DE)

(73) Assignee: Rausch & Pausch GmbH, Selb (DE)

(21) Appl. No.: 15/698,910

(22) Filed: Sep. 8, 2017

(30) Foreign Application Priority Data
Sep. 8, 2016 (DE) 10 2016 116 848.3

(51) Int. Cl. F16K 17/06; F16K 7/12; F16K 1/12; G05D 7/01; B60G 17/08

(52) U.S. Cl. CPC F16K 17/065; F16K 7/12; F16K 1/12; F16K 31/0675; G05D 7/0113; B60G 17/08; G05D 7/0126

(57) ABSTRACT

A pressure reducing valve of an air damping system of motor vehicle chassis makes available a constant output pressure when the input pressure varies. The pressure reducing valve has a housing with a general longitudinal axis, at least one fluid input opening and at least one axial fluid passage opening. In the housing a valve piston with a valve body is mounted displaceably which forms a seat valve with the axial fluid passage opening. An elastic diaphragm arranged stationarily in the housing is coupled to the valve piston and forms two axially active differential pressure areas. A pressure return passage penetrates the valve piston and guides an output pressure present downstream of the seat valve onto the elastic diaphragm.

### FIELD

The invention relates to a pressure reducing valve, in particular a pressure reducing valve for pneumatic systems, such as usable for example in air damping systems of motor vehicles. Correspondingly, the invention further relates to an air damping system of a motor vehicle chassis.

### BACKGROUND

Pressure reducing valves are used in fluid technology for reducing an input pressure to a fixed target output pressure. There are many areas of application. Pressure reducing valves are available for both hydraulic and pneumatic applications. Pressure reducing valves are widespread in gas supply systems, for example. Pressure reducing valves with high input pressures are used for example for gas cylinders with up to around 200 bar storage pressure. For this area of use regulation errors are known upon a decrease of the storage pressure, in particular increases in pressure. In order to reduce this regulation error, two-tier pressure reducing valves are partly used.

In addition to actively regulating valves, also pneumatic throttles are used for pressure reduction. However, two preconditions are required in order to regulate the output pressure constantly, since the input pressure on the one hand and the volume flow on the other hand have to be constant. To many applications this does not apply.

Mechanical pressure reducing valves, such as the one of the present invention, are based on the functional principle that the flow cross section in the valve changes autonomously in dependence on the controlled process variable (output pressure). This change is achieved through force differences on the active, moved components, the so-called actuators, in the valve. Since the valve is to react to the output pressure, the movement of the actuator in the valve has to be connected with the output pressure. This is achieved by connecting the actuator on a front side with the controlled pressure (output pressure) of the pressure reducing valve, thereby producing an actuating force in dependence on the controlled pressure. In order to produce this force, a constant, lower pressure, which usually is the atmospheric pressure, has to be present on the referenced front areas, i.e. the front areas disposed opposite the front region where the controlled pressure is applied.

When the controlled pressures are low, like in the concrete case of application of the present invention in an air load in a motor vehicle, where the differential pressure can sink as far as to 0.5 bar, the actuating forces obtainable through the controlled pressure (output pressure) are limited. In such cases the actuating forces are increased to the required levels by employing actuating elements with differential areas of corresponding geometrical size, for example by employing elastomer diaphragms with large diameters of 100 mm, for example. High actuating forces are required in particular in order to be able to execute the actuating movement at all, for example against a spring bias, on the one hand, and in order to overcome disturbing influences on the other hand, which are caused by the friction in the bearing of the actuator assembly for example, friction on dynamic seals and the like, and to limit the hysteresis of pressure regulation resulting therefrom.

The pressure reducing valve according to the invention is used preferably in the area of pneumatics, in particular in the area of air damping systems for motor vehicles. The pressure reducing valve serves to supply an air load in the vehicle with constant pressure. The pressure supply is usually effected from a storage vessel, the filling pressure of which varies in line with the filling state of the storage vessel. The pressure reducing valve here assumes the function of providing the load with a constant supply pressure independently of the varying filling pressure of the storage vessel. This supply pressure can be at a relatively low level of 0.5 bar to 1.0 bar, while the filling pressure of the storage vessel is at a relatively high pressure level in comparison thereto of up to 20 bar. When the storage vessel is fully loaded, the pressure ratio at the pressure reducing valve thus amounts to 20 bar to 0.5 bar.

### SUMMARY

It is the object of the present invention to propose a pressure reducing valve of the type described at the outset, which yields an output pressure that is as constant as possible, while the input pressure varies.

According to a preferred embodiment, the pressure reducing valve providing a constant output pressure while the input pressure varies comprises firstly a housing with a general longitudinal axis, at least one fluid input opening and at least one axial fluid passage opening. In the housing a valve piston is mounted displaceably along the longitudinal axis, said valve piston having a valve body forming a seat valve together with the at least one axial fluid passage opening. In the housing further an elastic diaphragm is arranged stationarily, said diaphragm being coupled to the valve piston and forming two axially acting differential pressure areas. By applying different pressures to the differential pressure areas, thus the valve piston moves back and forth axially in the housing. For this purpose a pressure return passage is provided which guides an output pressure, the controlled pressure, present downstream of the seat valve, onto one of the two differential pressure areas of the elastic diaphragm. At the other one of the two differential pressure areas, preferably atmospheric pressure is present. Special importance is attributed to the active areas of the valve piston, on which the input pressure acts that is present at the fluid input opening. These active areas of the valve piston are configured such that the axial pressure forces present there compensate each other, so that the input pressure does not exert an axial actuating force on the valve piston. Thereby the influence of a changing input pressure on the pressure regulation of the pressure reduction valve is minimized.

In order to mutually offset the axial pressure forces exerted by the input pressure on the valve piston, a preferred embodiment of the invention provides that on the one hand the valve body of the valve piston closes the at least one axial fluid passage opening on the output side, and on the other hand a maximal radial cross-section area of the valve piston in a region of the valve piston in which the input pressure present at the at least one fluid input opening acts in a closing direction of the valve piston corresponds to the cross-section area on the output side of the at least one axial fluid passage opening. For then the same pressure force acts on the valve body of the valve piston arranged on the output side of the fluid passage opening in the reverse direction of the pressure force caused by the input pressure which urges the valve piston in the closing direction.

The pressure return passage, by means of which the output pressure (controlled pressure) is guided onto the elastic diaphragm, can extend in a wall of the housing, for example. However, it is preferred when the pressure return passage penetrates the valve piston. The construction space of the valve can be kept small in this manner. For example, the pressure return passage can be realized as a central axial bore in the valve piston.

Active areas of the valve piston and of the diaphragm, on which the output pressure present downstream of the valve seat acts, are configured such that axial pressure forces present at these active areas are added up.

The valve piston can be urged into an open position of the seat valve by axial spring biasing. Therein a basic position of the valve piston, for example a position in which atmospheric pressure is present at the fluid output and at the fluid input opening, can be adjusted by means of a mechanical actuator. Alternatively or additionally, the basic position of the valve piston can be adjusted by means of an electromagnetic drive.

The pressure reducing valve according to the invention can be configured as an autonomous valve, to which a pressure input line and a pressure output line are connected. Alternatively, the pressure reducing valve can be configured as a cartridge for insertion in a valve block. For this purpose the pressure reducing valve has a circumferential sealing area on an outer surface of the housing, which can cooperate with a circumferential sealing element, for example one or several o-rings. The circumferential sealing element can form part of the pressure reducing valve.

The pressure reducing valve is adapted such that the input pressure can vary between 1 and 10 bar, preferably between 0.5 and 12 bar, and the constant output pressure is adjustable or adjusted to between 0.5 and 1 bar. When the input pressure amounts to only 0.5 bar, the constant output pressure can of course not be regulated to 1 bar, but only to 0.5 bar. This functionality can be realized by a pressure reducing valve according to the invention with a surprisingly small construction size and consequently makes it particularly suitable for use in an air damping system of a motor vehicle chassis, where size and weight are of particular importance. If higher pressures are to be regulated down, two pressure reducing valves according to the invention can be connected in series.

The elastic diaphragm is preferably an elastomer diaphragm. A diaphragm with the following properties has proven to be particularly suitable: NBR rubber (nitride butadiene rubber) with a hardness of 70 Shore A, a thickness of 0.3 mm and an outer diameter of 14 mm (with central bore for attachment to the valve piston). The hardness can be between 60 and 80 Shore A, the thickness between 0.2 and 0.4 mm and/or the outer diameter between 5 and 30 mm.

The valve seat likewise preferably encompasses an elastomeric seat area, however which is used only when the pressure present at the load exceeds the provided input pressure and closes the valve.

For separating the high pressure and the low pressure chambers within the housing, i.e. on the one hand the chamber where the input pressure is present, and on the other hand the chamber adjoining the elastic diaphragm, into which the output pressure (controlled pressure) is guided through the pressure return passage, a dynamic seal can be provided. Particularly preferably the dynamic seal described in DE 10 2011 082 007 B3 is used for this purpose. With reference to the structure of such a dynamic seal, explicit reference is made to the content of DE 10 2011 082 007 B3. The use of a dynamic seal prevents any leakage flows between the high pressure and the low pressure chambers.

To avoid hysteresis influences on the pressure regulation, a gap ring is preferred, however. Gap rings can be configured to be almost frictionless through suitable material partners. Thus, in the housing of the pressure reducing valve, a sleeve can be provided in which the valve piston slides axially, wherein the sleeve can advantageously consist of polytetrafluoroethylene (PTFE), while the valve piston consists of aluminum, for example. Other low-friction materials that can be used instead of the polytetrafluoroethylene are plastics in particular, due to their being manufacturable inexpensively. The gap width of the radial gap is preferably in the range of 0.01 to 0.08 mm. The length of the gap amounts to at least 5 mm, preferably at least 15 mm. Alternatively, the housing itself can consist of PTFE and replace the sleeve.

The gap ring involves the disadvantage, however, that there exists a minimal leakage from the high pressure chamber (input pressure) to the low pressure chamber (output pressure or controlled pressure) adjoining the elastic diaphragm. For the quality of regulation this is irrelevant as long as the volume flow consumed by the load is larger than the leakage flow through the gap ring. However, when the load does no longer consume a volume flow, it is advantageous to connect a check valve in series with the pressure reducing valve, so that the pressure at the output of the pressure reducing valve does not increase. This check valve is advantageously connected upstream of the pressure reducing valve, but can also be provided downstream of the pressure reducing valve.

By means of the gap ring, the friction within the pressure reducing valve and thereby a hysteresis of the pressure regulation is almost eliminated, so that a very high quality of regulation can be achieved with geometrically small and compact components with small actuation forces.

### BRIEF DESCRIPTION OF THE FIGURES

Hereinafter the invention will be described by way of example with reference to the accompanying drawings. The figures are described as follows:

FIG. 1 a pressure reducing valve in a perspective view,

FIG. 2 the pressure reducing valve of FIG. 1 in cross section according to a first embodiment example,

FIG. 3 the pressure reducing valve of FIG. 1 according to a second embodiment example,

FIG. 4 a pressure reducing valve according to a third embodiment example in cartridge construction type and

FIG. 5 a pressure reducing valve according to a fourth embodiment example, again in cartridge construction type like in FIG. 4, but with an electromagnetic actuation device.

### DETAILED DESCRIPTION OF THE FIGURES

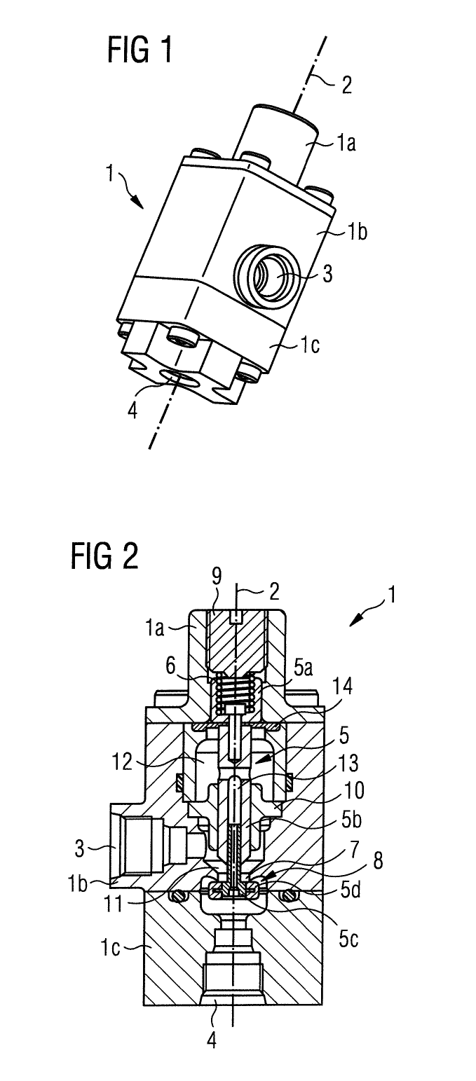

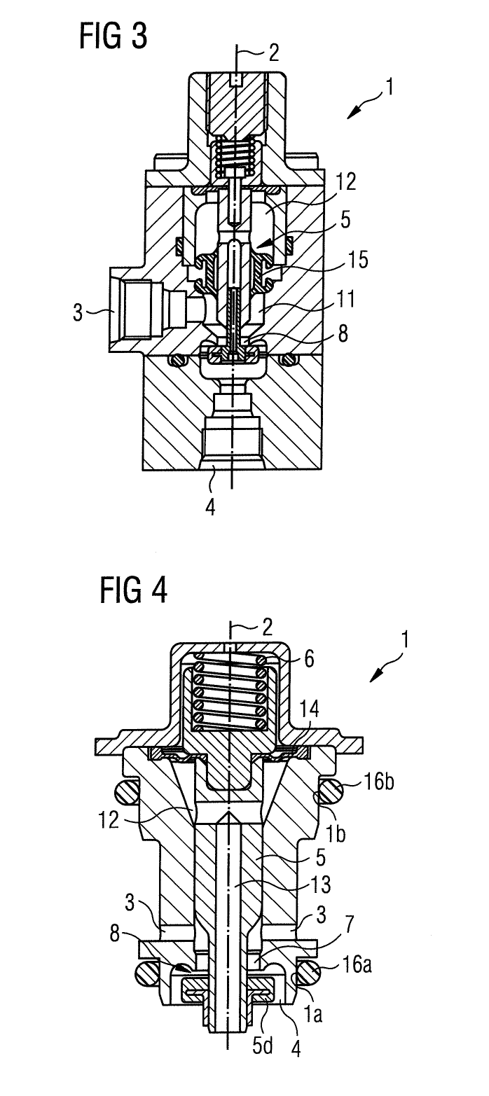

FIG. 1 shows a pressure reducing valve in a perspective view, with a housing 1, a general longitudinal axis 2, a radial fluid input opening 3 and an axial fluid output opening 4. FIGS. 2 and 3 show two alternative embodiment examples of this pressure reducing valve in cross section.

The housing 1 is constructed of several parts and in the embodiment examples according to FIGS. 1 to 3 consists of three housing parts 1a, 1b, 1c. In the housing a valve piston 5 is mounted so as to be axially displaceable. The valve piston 5 is likewise configured to have several parts. A first axial end of the valve piston 5 is formed by the valve piston part 5a and rests against a biasing spring 6 in the housing part 1a. The second axial end of the valve piston 5 is formed by the valve piston part 5c, which has a valve body 5d forming a seat valve 8 together with a fluid passage opening 7 in the central housing part 1b. The valve body 5d consists of an elastomeric material. The valve piston parts 5a and 5c, which form the two axial ends of the valve piston 5, are fixedly interconnected by a central valve piston part 5b. The spring force of the biasing spring 6 urges the valve piston 5 into an open position of the seat valve 8, so that the seat valve opens as soon as the output pressure present at the pressure output 4 undershoots a preset value. In contrast, when the output pressure is at the value adjusted by means of the biasing spring 6 and the load does not consume fluid, or when the output pressure even increases beyond the preset value, the seat valve 8 closes against the biasing force of the biasing spring 6. This biasing force is mechanically adjustable by means of an adjusting screw 9 in the housing part 1a against which the biasing spring 6 rests.

The central valve piston part 5b is mounted so as to be axially displaceable in a stationarily arranged sleeve 10. By suitably choosing the material pair of the sleeve and the valve piston, this mounting can be configured to be almost frictionless. For example, the sleeve 10 can consist of polytetrafluoroethylene (PTFE) and the central valve piston part 5b of polished aluminum or likewise of plastic. Together with the central valve body part 5 the sleeve 10 forms a gap ring that separates two housing chambers 11 and 12 from each other. The first chamber 11 is a high pressure chamber in which the input pressure is active which is present at the fluid input opening 3. The second chamber 12 is a low pressure chamber in which the output pressure is active which is present downstream of the seat valve 8. For this purpose, the valve piston 5 penetrates a pressure return passage 13 through which the output pressure is guided into the low pressure chamber 12.

The low pressure chamber 12 is limited by a diaphragm 14 at an axial end, said diaphragm being fixed stationarily on the outside of the housing 1 and being attached to the movably mounted valve piston on the inside. On the one side of the diaphragm 14, namely in the low pressure chamber 12, thus the output or controlled pressure is active. On the opposite side of the diaphragm atmospheric pressure is active at all times. The diaphragm 14 is elastic. Correspondingly, a changing output pressure downstream of the seat valve 8 is guided through the pressure return passage 13 into the high pressure chamber 12 and there exerts a correspondingly changing pressure force on the elastic diaphragm 14, which, due to its coupling to the valve piston 5, causes the valve piston 5 to move in the one or the other axial direction in accordance with the change of the pressure force. In this manner, the output pressure or controlled pressure is guided back onto the valve piston 5, so that the output pressure is regulated by means of the pressure reducing valve.

In order to achieve that this pressure regulation is as independent as possible of the input pressure present at the fluid input opening 3, the active areas of the valve piston on which the input pressure acts (these are the active areas of the valve piston in the high pressure chamber 11) are configured such that axial pressure forces present at these active areas compensate each other. It is thus achieved that the input pressure does not exert an axial actuating force on the valve piston 5. Concretely, this is achieved in the embodiment examples according to FIGS. 2 and 3 by the central valve piston part 5b having a cross section area which corresponds to the cross section of the fluid passage opening 7 on the output side, and the valve body 5d of the valve piston 5 closing this fluid passage opening 7 from the exit side. As can be verified easily on the basis of the representation of FIG. 2, then on the one hand, in the high pressure chamber 11, axial pressure forces act on the central valve piston part 5b (contrary to the spring bias) and on the other hand axial pressure forces in the opposite direction act on the valve piston part 5c and valve body 5b in the region of the fluid passage opening 7, wherein these pressure forces offset each other due to the identical cross section areas.

While the axial active areas of the valve piston in the region of the high pressure chamber 11 are configured so that axial pressure forces present at these active areas compensate each other, with reference to the output pressure present there and being guided back through the pressure return passage 13, the valve piston 5 is configured so that the pressure forces present and axially active at the valve piston part 5c and the axial pressure forces present at the diaphragm 14 add up.

By means of the mechanical actuator 9, the pressure reducing valve can be adjusted to a constant output pressure between 0.5 and 1 bar. Also different, in particular higher pressures are possible with different spring forces. The valve is suitable for systems with input pressures of up to 12 bar. Since, due to tolerances, the influence of the input pressure on the pressure regulation cannot be prevented entirely, in the case of very large pressure differences between the input pressure and the output pressure, in the concrete example thus in the case of pressure differences of over 12 bar, two such pressure reducing valves can be connected in series, in order to regulate pressure differences of over 20 bar then.

The pressure reducing valve is of a relatively small construction size. The square cross section area of the housing 1 has an edge length of 30 mm×30 mm. The complete axial construction length amounts to only 67 mm. The diameter of the valve piston in the region of the central valve piston part 5b mounted in the sleeve 10 amounts to merely 5.8 mm, and the diameter of the fluid passage opening 7 is correspondingly small. The diaphragm 14 has an outer diameter of only around 14 mm, possibly ±50%.

While the almost frictionless gap ring of the pressure reducing valve according to the embodiment example of FIG. 2 has only a minimal hysteresis, a fluid flow between the high pressure chamber 11 and the low pressure chamber 12 cannot be neglected entirely. This influence is unimportant during the operation of the pressure reducing valve. However, when the pressure reducing valve closes, since there is a relatively high pressure present at the load, i.e. at the fluid output opening 4, or no volume flow is consumed by the load, these leakage flows from the pressure storage through the gap ring to the load can be undesirable. For this case it is expedient to connect a check valve immediately downstream of the pressure reducing valve, or preferably immediately upstream thereof (not represented).

The embodiment example according to FIG. 3 differs from the embodiment example according to FIG. 2 in that a dynamic seal is provided instead of the previously described gap ring. The dynamic seal, which typically consists of an elastomer material, offers the advantage that leakage flows between the high pressure chamber 11 and the low pressure chamber 12 are prevented entirely. However, this pressure reducing valve has a greater hysteresis due to the higher friction forces between the dynamic seal 15 and the valve piston 5.

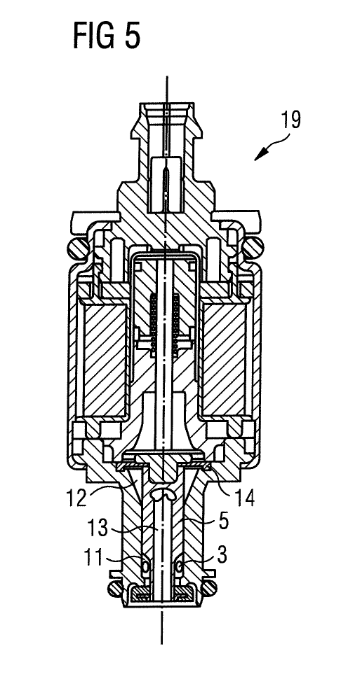

FIG. 4 shows a third embodiment example of a pressure reducing valve that does not differ substantially from the embodiment example according to FIG. 2 functionally. Due to the construction type, the spring biasing force is predetermined and not adjustable. In particular, a gap ring is realized also here between the valve piston 5 and the housing 1. For this purpose the entire housing can be configured of a correspondingly low-friction material, such as polytetrafluoroethylene (PTFE) or a different plastic, as shown in FIG. 4, or an additional sleeve, similar to the sleeve 10 in FIG. 2, can be provided between the valve piston 5 and the housing 1 (not represented). Otherwise, the substantial difference of this third embodiment example according to FIG. 4 with reference to the previously described embodiment examples consists in that the pressure reducing valve is configured as a “cartridge” which can be inserted in a corresponding valve block in sealing manner. Different to the pressure reducing valves represented in FIGS. 1 to 3, the pressure reducing valve in cartridge form according to FIG. 4 is of rotation-symmetrical construction with reference to the general longitudinal axis 2, however which is not mandatory. On the circumference of the housing 1 sealing areas 1a and 1b are provided, which cooperate with corresponding sealing elements 16a and 16b, preferably o-rings. Depending on the application case, also more or possibly fewer sealing areas and sealing elements can be present.

Different to the representations of the embodiment examples according to FIGS. 2 and 3, the pressure reducing valve according to FIG. 4 is represented with a valve seat 8 disposed in the open position, which corresponds to the typical operational state. The functional principle will be explained once again hereinafter on the basis of FIG. 4. At the pressure input opening 3, a pressure of 10 bar for example is present, which is regulated down to an output pressure of 0.5 bar for example, through the reducing effect of the seat valve 8. When the input pressure changes to 5 bar for example, since a pressure storage of a motor vehicle air damping system now makes available only a low pressure for example, the changing pressure difference between the input pressure and the output pressure of 9.5 bar to 4.5 bar results in a reduced volume flow through the seat valve 8. The reduced volume flow causes a pressure drop of the output pressure to a value below 0.5 bar. This reduced output pressure is guided into the low pressure chamber 12 through the pressure return passage 13. Thus, a lower pressure acts on the elastic diaphragm 14, so that the biasing force of the biasing spring 6 results in an axial displacement of the valve piston 5 in the direction of a larger open position of the seat valve 8. Correspondingly, more fluid flows through the seat valve 8 to the fluid output opening 4, the pressure at the fluid output opening 4 increases correspondingly, and the pressure is regulated back to the preset pressure level of 0.5 bar at the pressure output opening 4.

FIG. 5 shows a pressure reducing valve according to a fourth embodiment example, however which differs from the pressure reducing valve according to FIG. 4 only in that an electromagnetic actuator 19 is provided. The electromagnetic actuator 19 can be provided instead of the mechanical actuator 9 also in the other embodiment examples. It is also possible to provide the mechanical actuator 9 and the electromagnetic actuator 19 in combination.

1. A pressure reducing valve which makes available an approximately constant output pressure when the input pressure varies, comprising
a housing with a general longitudinal axis, at least one fluid input opening and at least one axial fluid passage opening,
a valve piston mounted in the housing to be displaceable along the longitudinal axis and having a valve body which, downstream of the at least one axial fluid passage opening, forms a seat valve together with said fluid passage opening,
an elastic diaphragm arranged stationarily in the housing and coupled to the valve piston, said diaphragm forming two axially acting differential pressure areas, and
a pressure return passage guiding an output pressure present downstream of the seat valve onto one of the two differential pressure areas of the elastic diaphragm,
wherein the active areas of the valve piston, on which there acts an input pressure present at the at least one fluid input opening, are configured such that axial pressure forces present at these active areas so compensate each other that the input pressure does not exert an axial actuating force on the valve piston.

2. The pressure reducing valve according to claim 1, wherein at the other one of the two differential pressure areas of the elastic diaphragm atmospheric pressure is present.

3. The pressure reducing valve according to claim 1, wherein the pressure return passage penetrates the valve piston.

4. The pressure reducing valve according to claim 3, wherein active areas of the valve piston and the diaphragm, on which the output pressure present downstream of the seat valve acts, are configured such that axial pressure forces present at these active areas add up.

5. The pressure reducing valve according to claim 1, wherein the at least one fluid input opening is a radial passage opening with reference to the general longitudinal axis of the housing.

6. The pressure reducing valve according to claim 1, wherein the at least one valve body of the valve piston closes the at least one axial fluid passage opening on the output side, and a maximal radial cross section area of the valve piston in a region of the valve piston in which the input pressure present at the at least one fluid input opening acts in a closing direction of the valve piston corresponds to the output-side cross section area of the at least one axial fluid passage opening.

7. The pressure reducing valve according to claim 1, wherein the valve piston is urged in an open position of the seat valve by axial spring biasing.

8. The pressure reducing valve according to claim 1, wherein a basic position of the valve piston is adjustable by means of a mechanical actuator.

9. The pressure reducing valve according to claim 1, wherein a basic position of the valve piston is adjustable by means of an electromagnetic actuator.

10. The pressure reducing valve according to claim 1, comprising at least one circumferential sealing area on an outer surface of the housing for cooperation with at least one circumferential sealing element, so that the pressure reducing valve is insertable in sealing manner as a cartridge in a valve block.

11. The pressure reducing valve according to claim 1, wherein the input pressure can vary between 1 and 10 bar.

12. The pressure reducing valve according to claim 1, wherein the constant output pressure lies between 0.5 and 1 bar.

13. The pressure reducing valve according to claim 1, wherein the elastic diaphragm is an elastomer diaphragm.

14. The pressure reducing valve according to claim 13, wherein the elastomer diaphragm has a Shore A hardness between 60 and 80, a thickness between 0.2 and 0.4 mm and an outer diameter between 5 and 30 mm.

15. The pressure reducing valve according to claim 1, wherein the seat valve comprises an elastomeric seat area.

16. The pressure reducing valve according to claim 1, wherein between the valve piston and the housing an elastomeric dynamic seal is provided, which seals a chamber of the housing in which the input pressure is active that is present at the at least one fluid input opening against a chamber of the housing in which the output pressure is active that is guided trough the pressure return passage and present downstream of the seat valve.

17. The pressure reducing valve according to claim 1, wherein radially between the valve piston and the housing a gap ring is provided which seals one chamber of the housing in which the input pressure is active that is present at the at least one fluid input opening against a chamber of the housing in which the output pressure is active that is guided trough the pressure return passage and present downstream of the seat valve.

18. The pressure reducing valve according to claim 17, wherein the gap ring has a radial gap width between 0.1 and 0.8 mm and a gap length of at least 5 mm.

19. The pressure reducing valve according to claim 17, comprising a check valve connected upstream of the fluid input opening or downstream of the fluid passage opening.

20. An air damping system of a motor vehicle chassis, comprising at least one pressure reducing valve,
which makes available an approximately constant output pressure when the input pressure varies, comprising
a housing with a general longitudinal axis, at least one fluid input opening and at least one axial fluid passage opening,
a valve piston mounted in the housing to be axially displaceable along the longitudinal axis and having a valve body which, downstream of the at least one axial fluid passage opening, forms a seat valve together with said fluid passage opening,
an elastic diaphragm arranged stationarily in the housing and coupled to the valve piston, said diaphragm forming two axially acting differential pressure areas, and
a pressure return passage guiding an output pressure present downstream of the seat valve onto one of the two differential pressure areas of the elastic diaphragm,
wherein the active areas of the valve piston, on which there acts an input pressure present at the at least one fluid input opening, are configured such that axial pressure forces present at these active areas so compensate each other that the input pressure does not exert an axial actuating force on the valve piston.

21. The air damping system according to claim 20, comprising a pressure storage making available the input pressure present at the fluid input opening of the pressure reducing valve and having a varying storage pressure in dependence on the filling state.

22. The air damping system according to claim 20, wherein two of the pressure reducing valves are connected in series.
